(19) United States
(12) Patent Application Publication
(10) Pub. No.: US 2023/0166929 A1
(43) Pub. Date: Jun. 1, 2023

(54) PAPER ALIGNING MECHANISM AND IMAGE GENERATING DEVICE HAVING THE SAME

(71) Applicant: KINPO ELECTRONICS, INC., NEW TAIPEI CITY (TW)

(72) Inventors: Hung-Huan SUNG, NEW TAIPEI CITY (TW); Yu-Cheng HUANG, NEW TAIPEI CITY (TW); Kai-Hong HU, NEW TAIPEI CITY (TW)

(21) Appl. No.: 17/572,430

(22) Filed: Jan. 10, 2022

(30) Foreign Application Priority Data
Nov. 29, 2021 (CN) 202111430155.5

(51) Int. Cl. B65H 5/06; B65H 9/00

(52) U.S. Cl. CPC B65H 5/06; B65H 9/004; B65H 2301/331; B65H 2801/06

(57) ABSTRACT

A paper aligning mechanism and an image generating device having the same are provided, the paper aligning mechanism is arranged on a calibration path of the image generating device, the calibration path is arranged between a paper assigning mechanism and a paper-feeding mechanism of the image generating device, and the paper aligning mechanism has at least two calibrating swingarms arranged spacedly. Each of the calibrating swingarms has an arm portion and a pivoting axle portion arranged on the arm portion to pivotally connect the arm portion to the image generating device. The arm portion has an extending segment and a limiting segment extended from the extending segment, the limiting segment is downward extended along the calibration path toward an exit of the calibration path to be swingable and to block the exit of the calibration path.

### BACKGROUND OF THE DISCLOSURE

### Technical Field

This disclosure is directed to a mechanism for transferring paper sheets and in particular to a paper aligning mechanism and an image generating device having the same.

### Description of Related Art

In order to capture an image from a paper sheet or print that on a paper sheet, a related image generating devices such as a scanner, a printer or a copying machine is provided with rollers for scrolling a paper sheet so as to transfer the paper sheet.

However, during the aforementioned process of scrolling the paper sheet, a difference between the frictions at left and right sides on the moving paper sheet may lead to skew and a calibration is therefore required. According to related solutions, a position of the paper sheet is detected by a sensor to derive an amount of skew, and feeding speeds of the rollers at left and right sides of the paper sheet are controlled by motors for calibrating, or rotations of the rollers are controlled by the clutches to calibrate the skew side and the paper sheet is then being transferred.

According to the related main solutions, additional power or related electronic components for precise calculations are required. Therefore, the overall volume of the device should be designed corresponding to an arrangement of the aforementioned power or electronic components, and the aforementioned solutions are not suitable for a compact mode therefore.

In view of the above drawbacks, the inventor proposes this disclosure based on his expert knowledge and elaborate researches in order to solve the problems of related art.

### SUMMARY OF THE DISCLOSURE

This disclosure mainly aims to provide a paper aligning mechanism and an image generating device having the same. A calibration to a paper sheet may be performed only by physical characteristics of friction from the designed structures without additional power or related electronic components.

This disclosure additionally aims to provide a paper aligning mechanism occupying less volume or space in the device and suitable for a compact design.

In order to achieve the aforementioned purpose, this disclosure provides a paper aligning mechanism disposed on a calibration path of an image generating device, the calibration path is disposed between a paper assigning mechanism and a paper-feeding mechanism of the image generating device. The paper aligning mechanism has at least two calibrating swingarms arranged spacedly. Each of the calibrating swingarms has an arm portion and a pivoting axle portion arranged on the arm portion to pivotally connect the arm portion to the image generating device, and the arm portion has an extending segment and a limiting segment extended from the extending segment. The limiting segment is downward extended along the calibration path toward an exit of the calibration path to be swingable and to block the exit of the calibration path.

In order to achieve the aforementioned purpose, this disclosure provides an image generating device having a device body, a paper assigning mechanism and a paper-feeding mechanism. An operation area and an output area are arranged in the device body, a calibration path and an input path are sequentially defined between the input area and the operation area, the input path communicates to the output area at an exit thereof through the operation area, and an image processor is arranged in the operation area. The paper assigning mechanism is arranged at an entrance of the calibration path, and the paper-feeding mechanism is arranged between an exit of the calibration path and an entrance of the input path. Two calibrating swingarms are arranged spacedly on the device body, each of the calibrating swingarms has an arm portion and a pivoting axle portion arranged on the arm portion to pivotally connect the arm portion to the device body. The arm portion has an extending segment and a limiting segment extended from the extending segment, the limiting segment is downward extended along the calibration path toward an exit of the calibration path to be swingable and to block the exit of the calibration path.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing an image generating device according to this disclosure.

FIG. 2 is a schematic view showing inner structures of the image generating device according to this disclosure.

FIG. 3 is a schematic view showing a calibration of the paper aligning mechanism to a paper sheet according to this disclosure.

FIG. 4 is a schematic view showing that the image generating device is fed with paper sheet according to this disclosure.

FIG. 5 is a schematic view showing that the paper sheet is calibrated by the paper aligning mechanism according to this disclosure.

FIG. 6 is a perspective view showing a paper aligning mechanism according to another embodiment of this disclosure.

FIG. 7 is a front view showing the paper aligning mechanism according to another embodiment of this disclosure.

FIG. 8 is a front view showing the paper aligning mechanism having additional calibrating swingarms corresponding to a central feeding arrangement.

FIG. 9 is a front view showing the paper aligning mechanism having additional calibrating swingarms corresponding to a side feeding arrangement.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

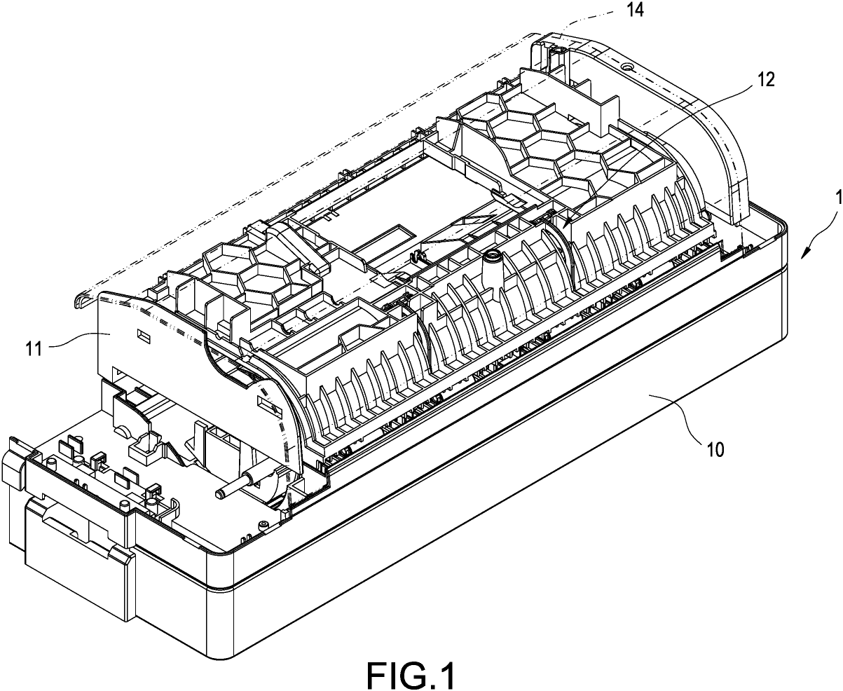

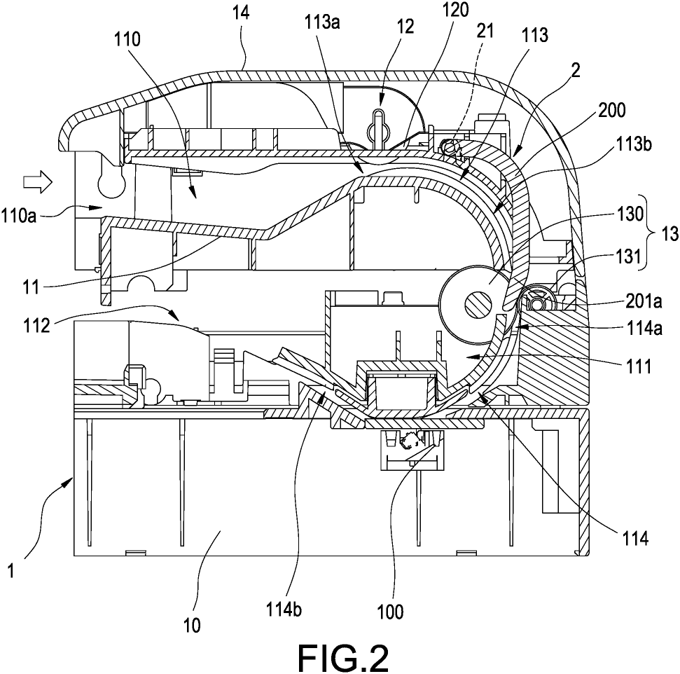

FIG. 1 and FIG. 2 are perspective views respectively showing an image generating device of this disclosure and inner structures thereof. A paper aligning mechanism and the image generating device having the same are provided in this disclosure, the image generating device 1 may be a scanner, a printer, or a copying machine namely a machine or a device which may capture an image (patterns, text, etc.) on a paper or print that on a paper. The image generating device 1 may have a base 10 and a device body 11 arranged on the base 10. An input area 110 for stacking paper sheets, an operation area 111 for performing image capture or printing processes to the paper sheets and an output area 112 for taking the paper sheets are defined in the device body 11. A calibration path 113 and an input path 114 are provided between the input area 110 and the operation area 111 for transferring the paper sheets sequentially, a paper assigning mechanism 12 is arranged at an entrance 113a of the calibration path 113, and a paper-feeding mechanism 13 is arranged between an exit 113b of the calibration path 113 and an entrance 114a of the input path 114. The input path 114 passes the operation area 111 so that an exit 114b of the input path 114 communicates to the output area 112, and an image processor 100 (for example, CMOS Image Sensor, CIS) is arranged in the operation area 111. According to an embodiment of this disclosure, a part of the aforementioned components may be arranged on the base 10, for example, the image processor 100 may be arranged on the base 10 and the device body 11 may be further provided with a cover 14 for covering the aforementioned components or parts.

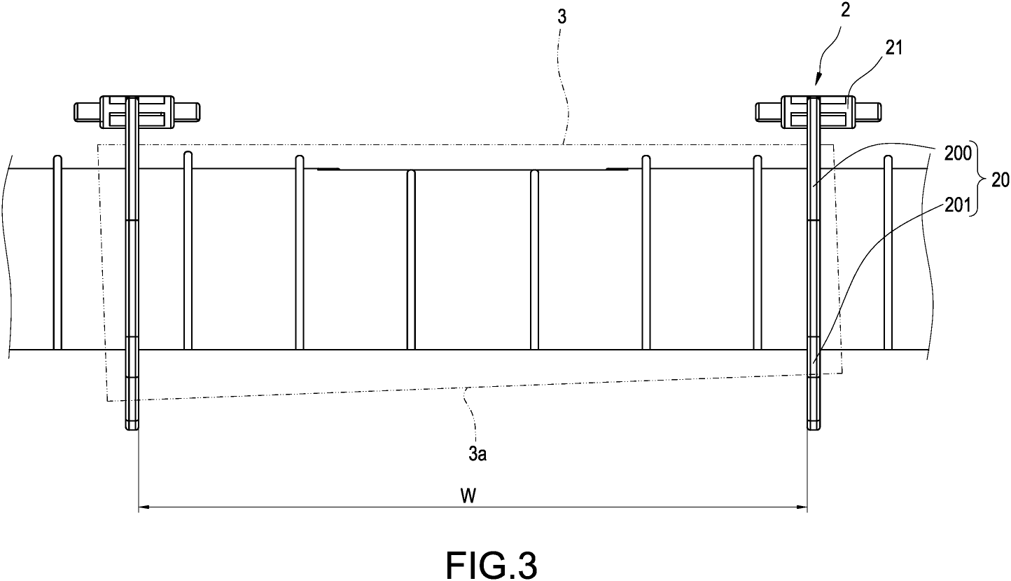

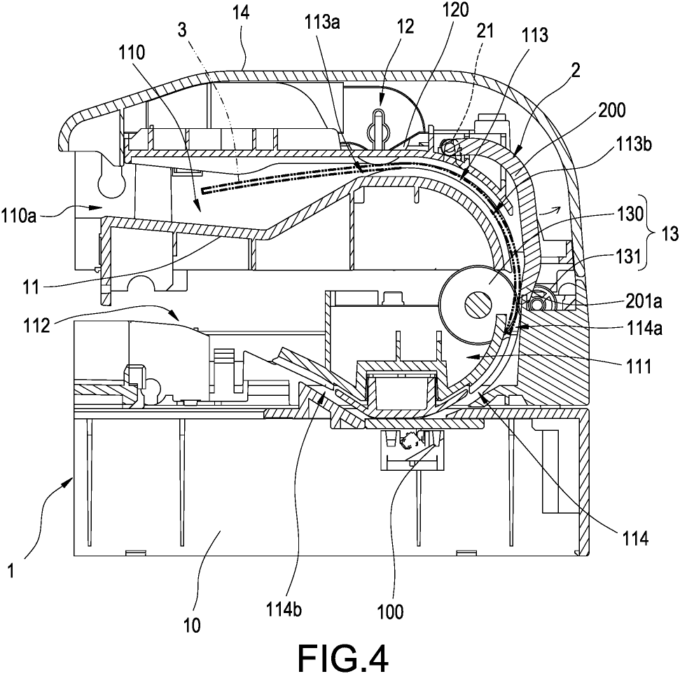

According to the aforementioned embodiment of this disclosure, two calibrating swingarms 2 are arranged by a spacing W on the device body 11. Specifically, according to FIG. 3 and FIG. 4, the spacing W between the two calibrating swingarms 2 is disposed approximately corresponding to a width (referring to a direction of feeding the paper sheet 3) of the paper sheet 3 being transferred, and each of the two calibrating swingarms 2 is provided with an arm portion 20 and a pivoting axle portion 21 arranged on the arm portion 20 to pivotally connect the arm portion 20 to a fixed position. The pivoting axle portion 21 may be pivotally positioned at an appropriate position on the device body 11 such as a position over the calibration path 113 and adjacent to a side of the paper assigning mechanism 12. The arm portion 20 has an extending segment 200 and a limiting segment 201 extended from the extending segment 200, the extending segment 200 may have a curved shape corresponding to the calibration path 113. According to the embodiment of this disclosure, a height difference is disposed between the paper assigning mechanism 12 and the paper-feeding mechanism 13, the calibration path 113 is correspondingly configured to be of a curved shape from top to bottom in order to occupy less space or volume in the device and it is therefore suitable for a compact design. Meanwhile, the limiting segment 201 is downward extended along the calibration path 113 toward the exit 113b of the calibration path 113 through the extending segment 200 to be swingable and to block the exit 113b of the calibration path 113.

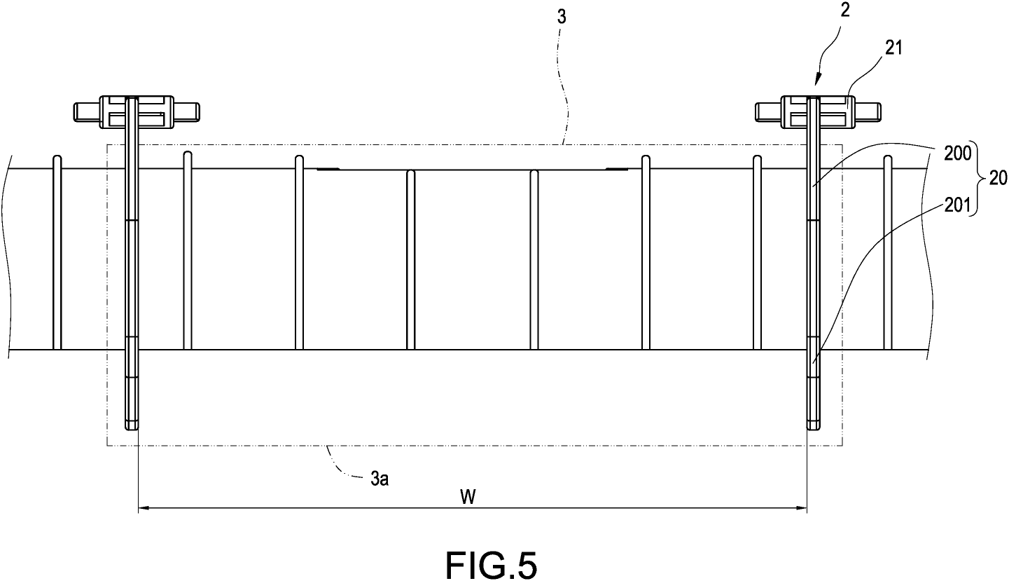

According to FIG. 4, the paper sheets 3 are sent into the input area 110 through the entrance 110a, and then the paper sheets 3 are sequentially transferred into the calibration path 113 by the paper assigning mechanism 12. The paper assigning mechanism 12 may has one or a plurality of coaxial rollers 120. Further according to FIG. 3, if the paper sheet 3 in the calibration path 113 is skew, left side or right side of a front edge 3a of the paper sheet 3 may contact the limiting segment 201 of the calibrating swingarm 2 in advance, the side of the front edge 3a of the paper sheet 3 may be decelerated by a friction caused by the contact, the other side of the front edge 3a may then follow up to compensate the skew, and the skew may be corrected as shown in FIG. 5. Once both two sides of the front edge 3a of the paper sheet 3 contact the limiting segments 201 of the two calibrating swingarms 2, the paper sheet 3 may be kept straight when moving into the paper-feeding mechanism 13 along the limiting segments 201 of the two calibrating swingarms 2. The paper sheets 3 are continuously scrolled toward the entrance 114a of the input path 114 by big and small rollers 130/131 of the paper-feeding mechanism 13 so as to pass the operation area 111 in the input path 114 for the image capture or printing processes and then pass the exit 114b of input path 114 and be stacked at the output area 112.

Further referring to FIG. 4 as well, it should be noted that the two calibrating swingarms 2 are pivotally disposed on an appropriate position on the device body 11 via the pivoting axle portions 21, and the limiting segment 201 may be slightly moved forward by the paper sheet 3 through the pivoting axle portion 21 when the front edge 3a of the paper sheet 3 contacts any one of the limiting segments 201 of the calibrating swingarm 2, so that the paper sheet 3 is therefore prevented from jam caused by continuously being pushed forward from the paper assigning mechanism 12 at a rear portion. Moreover, for the convenience of arranging a weight of the limiting segment 201 of each calibrating swingarm 2, an arm end may be inward extended from each limiting segment 201, so that the two limiting segments 201 may swing about the pivoting axle portion 21 and naturally generate a gravity toward the exit 113 of the calibration path 113.

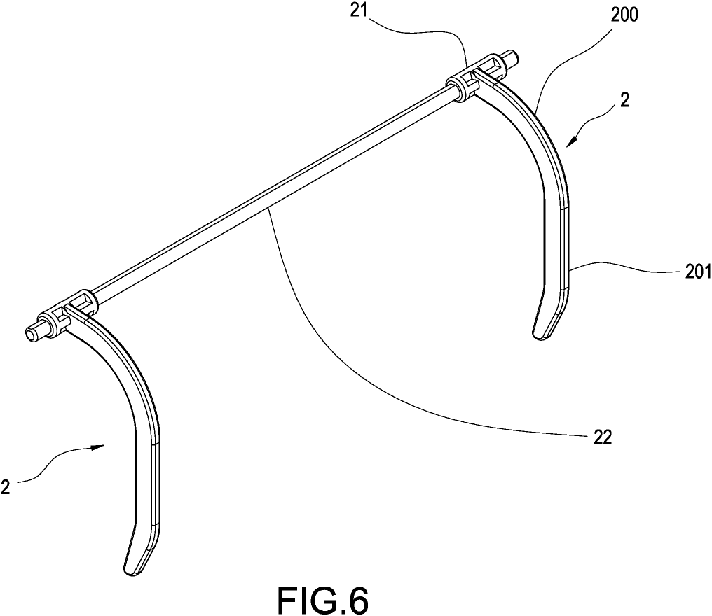

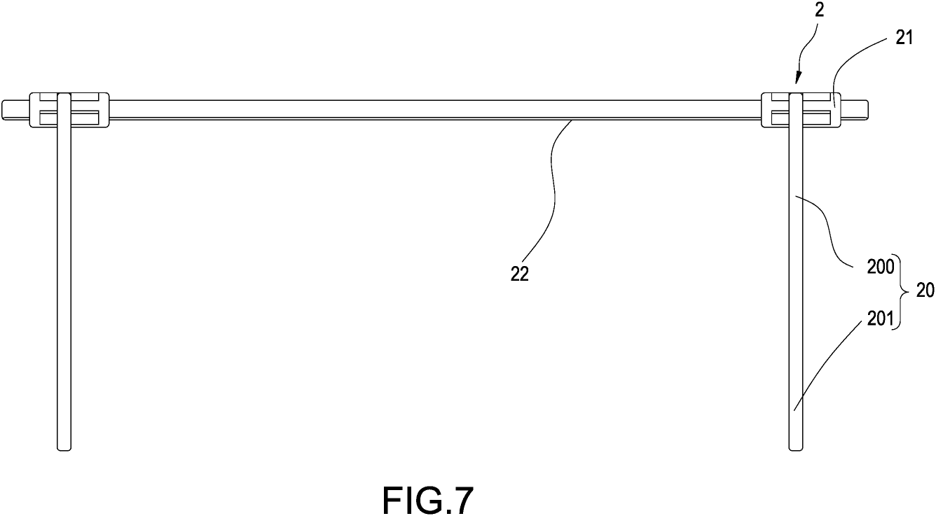

In addition, as shown in FIGS. 6 and 7, a linking shaft 22 may be arranged between the pivoting axle portions 21 of the two calibrating swingarms 2, so that when any one of the calibrating swingarms 2 is calibrating, another calibrating swingarm 2 may be synchronously linked via the linking shaft 22. Therefore, the calibration of the two limit segments 201 may be maintained consistently.

In addition, two methods “central feeding” and “side feeding” generally used for feeding pater are respectively described below.

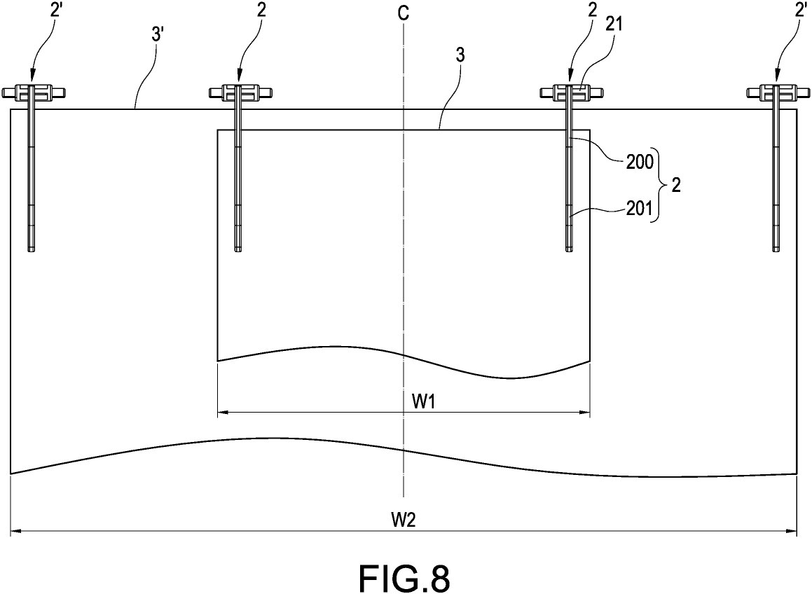

According to the “central feeding” method shown in FIG. 8, the paper sheet 3 may be positioned along a central axle C via two movable paper holders (omitted in Figs.) at two sides of the central axle C, according to a width W1/W2 of the paper sheet 3/3′. According to the paper aligning mechanism of this disclosure, the two calibrating swingarms 2 are disposed corresponding to a paper sheet 3 with smaller width W1, and a calibrating swingarm 2′ is additionally arranged beyond each side corresponding to another paper sheet 3′ with wider width W2.

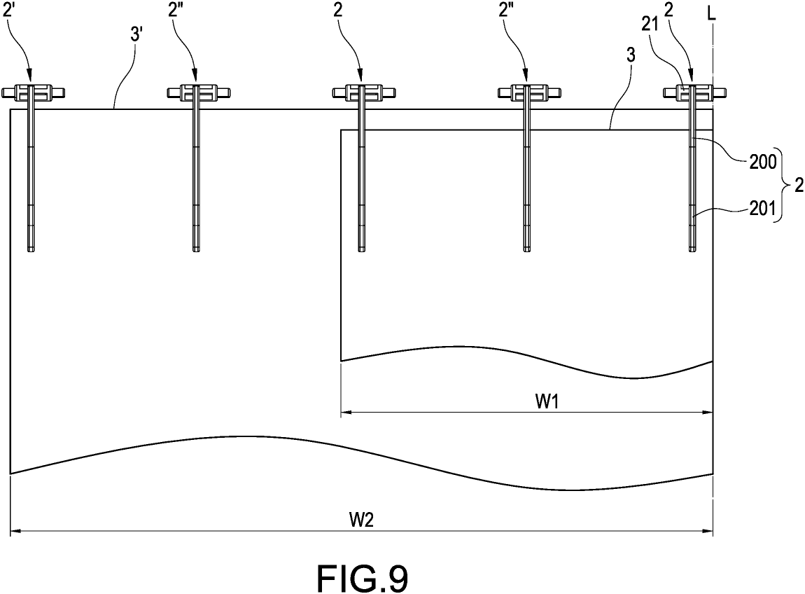

According to the “side feeding” method shown in FIG. 9 the paper sheet 3 may be positioned by a movable paper holder at one side opposite to a fixed paper holder at another side (omitted in Figs.) so as to position the paper sheet 3 at a fixed side L corresponding to a width W1/W2 of the paper sheet 3. The two calibrating swingarms 2 of this disclosure are disposed corresponding to a paper sheet 3 with smaller width W1 and an additional calibrating swingarm 2′ may be arranged corresponding to another paper sheet 3′ with wider width W2 outside the calibrating swingarm 2 away from the fixed side L in an interval the same as the spacing W. Alternatively, a calibrating swingarm 2″ may be additionally arranged between the two calibrating swingarms 2, or additionally arranged between the calibrating swingarm 2 away from the fixed side L and the additional calibrating swingarm 2′.

Accordingly, corresponding to size of the fed paper sheets 3, 3′, the spacing W between the two calibrating swingarms 2 may be adjusted, or calibrating swingarms 2′, 2″ maybe added so as to provide a force for calibrating or balancing the paper sheets 3, 3′.

Therefore, the paper aligning mechanism and the image generating device of this discloser may be implemented via the aforementioned structure.

While this disclosure has been described by means of specific embodiments, numerous modifications and variations could be made thereto by those skilled in the art without departing from the scope and spirit of this disclosure set forth in the claims.

What is claimed is:

1. A paper aligning mechanism, disposed on a calibration path of an image generating device, the calibration path disposed between a paper assigning mechanism and a paper-feeding mechanism of the image generating device, the paper aligning mechanism comprising: at least two calibrating swingarms arranged spacedly;
wherein each of the calibrating swingarms comprises:
an arm portion, comprising an extending segment and a limiting segment extended from the extending segment, and the limiting segment downward extended along the calibration path toward an exit of the calibration path to be swingable and to block the exit of the calibration path; and
a pivoting axle portion, arranged on the arm portion to pivotally connect the arm portion on the image generating device.

2. The paper aligning mechanism according to claim 1, wherein a linking shaft is arranged between the pivoting axle portions of the two calibrating swingarms.

3. The paper aligning mechanism according to claim 1, wherein the extending segment is of a curved shape corresponding to the calibration path.

4. The paper aligning mechanism according to claim 1, wherein an arm end is inward extended from the limiting segment.

5. The paper aligning mechanism according to claim 1, wherein the pivoting axle portion is pivotally disposed above the calibration path.

6. An image generating device, comprising:
a device body, comprising an input area, an operation area and an output area, a calibration path and an input path sequentially defined between the input area and the operation area, the input path communicating to the output area at an exit thereof through the operation area, and an image processor arranged in the operation area;
a paper assigning mechanism, arranged on an entrance of the calibration path; and
a paper-feeding mechanism, arranged between an exit of the calibration path and an entrance of the input path;
wherein two calibrating swingarms are arranged spacedly on the device body, each of the calibrating swingarms comprises an arm portion and a pivoting axle portion arranged on the arm portion to pivotally connect the arm portion to the device body, and the arm portion comprises an extending segment and a limiting segment extended from the extending segment, the limiting segment is downward extended along the calibration path toward the exit of the calibration path through the extending segment to be swingable and to block the exit of the calibration path.

7. The image generating device according to claim 6, wherein a base is arranged under the device body.

8. The image generating device according to claim 7, wherein the image processor is arranged on the base.

9. The image generating device according to claim 6, wherein a linking shaft is arranged between the pivoting axle portions of the two calibrating swingarms.

10. The image generating device according to claim 6, wherein the paper assigning mechanism is arranged over the paper-feeding mechanism and the calibration path is of a curved shape, and the extending segments of the two calibrating swingarms are of curved shapes corresponding to the calibration path.

11. The image generating device according to claim 6, wherein an arm end is inward extended from the limiting segment.

12. The image generating device according to claim 6, wherein the pivoting axle portion is pivotally disposed above the calibration path and adjacent to a side of the paper assigning mechanism.
